(19) United States
(12) Patent Application Publication
(10) Pub. No.: US 2026/0367419 A1
(43) Pub. Date: Nov. 19, 2026

(54) AERIAL IMAGE DISPLAY DEVICE

(71) Applicant: NTT, Inc., Tokyo (JP)

(72) Inventors: Ayami HOSHI, Musashino-shi (JP); Motohiro MAKIGUCHI, Musashino-shi (JP); Ayaka SANO, Musashino-shi (JP); Hiroshi CHIGIRA, Musashino-shi (JP); Takayoshi MOCHIZUKI, Musashino-shi (JP)

(73) Assignee: NTT, Inc., Tokyo (JP)

(21) Appl. No.: 19/515,828

(22) PCT Filed: Sep. 27, 2023
(86) PCT No.: PCT/JP2023/035133

§ 371 Date: Mar. 3, 2026

(51) Int. Cl. G02B 30/56

(52) U.S. Cl. CPC G02B 30/56

(57) ABSTRACT

An aerial image display device according to embodiments includes a display having a display surface facing from one end side to an other end side in a first direction, wherein an aerial image is displayed on a first surface including the first direction and a second direction intersecting the first direction; a beam splitter having a second surface; and a retro-reflective material having a third surface facing from the other end side to the one end side in the first direction. Light is reflected by the second surface. The light is retro-reflected by the third surface. The retro-reflected light is transmitted through the beam splitter from the other end side toward the one end side in the first direction. The transmitted light is reflected by the first surface. The light reflected by the first surface forms the aerial image.

### TECHNICAL FIELD

Embodiments relate to an aerial image display device.

### BACKGROUND ART

A technique of displaying an image of a display as an aerial image has been studied. For example, as disclosed in non-patent literature 1, there is known aerial imaging by retro-reflection (AIRR) that displays an aerial image by using a retro-reflective material and a beam splitter. In such a technique, a device that displays an aerial image is placed in front of the line of sight in many cases, and thus it may be difficult to blend the aerial image in an environment.

Therefore, non-patent literature 2 proposes a tabletop aerial image display system whose installation place is hardly limited. This system is called PortOn. In the system, the presence of the device is reduced by using a nearby reflective surface as a part of an optical system. This makes it possible to display an aerial image that blends in the environment.

### CITATION LIST

### Non-Patent Literature

Non-Patent Literature 1: Hirotsugu Yamamoto, “Aerial Display with Aerial Imaging by Retro-Reflection (AIRR)”, Journal of the Imaging Society of Japan, Vol. 56, No. 4, pp. 341-351, 2017, doi 10.11370/isj.56.341
Non-Patent Literature 2: Naoya Koizumi, Ayaka Sano, “Optical system to display mid-air images on a glossy plane and remove ground images”, Optics Express, vol. 28, Issue 18, pp. 26750-26763, 2020, doi 10.1364/OE.400104
Non-Patent Literature 3: Kota Murofushi, Naoki Hashimoto, “Wide Viewing-Angle Stereoscopic Aerial Imaging Combining Multiple Stereoscopic Displays”, Journal of the Virtual Reality Society of Japan, Vol. 25, No. 4, pp. 432-438, 2020, doi 10.18974/tvrsj.25.4_432
Non-Patent Literature 4: Tomoyo Kikuchi, Yuchi Yahagi, Shogo Fukushima, Saki Sakaguchi, Takeshi Naemura, “AIR-range: Designing optical systems to present a tall mid-AIR image with continuous luminance on and above a tabletop”, ITE Trans. on MTA, vol. 11, No. 2, pp. 75-87, 2023, doi 10.3169/mta.11.75

### SUMMARY OF INVENTION

### Technical Problem

However, in an optical system in which a line-of-sight direction and a display surface of a display are arranged to face each other as disclosed in non-patent literature 2, there may be a problem that transmission light that is simply transmitted through a retro-transmissive element without being retro-transmitted by the retro-transmissive element is observed by a user. In view of this, in non-patent literature 2, a visual field control film for removing an influence of transmission light directly viewed from the display as described above is arranged on an optical path. In such a case, it is problematic in that luminance and image quality of an aerial image deteriorate due to the visual field control film.

The present invention has been made in view of the above circumstances, and an object thereof is to provide means for preventing reduction in luminance and image quality caused by a measure for removing an influence of transmission light.

### Solution to Problem

An aerial image display device of an embodiment is an aerial image display device that displays an aerial image on a first reflective surface including a first direction and a second direction intersecting the first direction, the aerial image display device including: a display having a display surface facing from one end side to the other end side in the first direction; a beam splitter having a second reflective surface; and a retro-reflective material having a third reflective surface facing from the other end side to the one end side in the first direction, in which at least a part of first emission light based on display on the display surface is reflected by the second reflective surface of the beam splitter, at least a part of the reflected first emission light is retro-reflected by the third reflective surface of the retro-reflective material, at least a part of the retro-reflected first emission light is transmitted through the beam splitter from the other end side toward the one end side in the first direction, at least a part of the transmitted first emission light is reflected by the first reflective surface, and at least a part of the first emission light reflected by the first reflective surface forms the aerial image.

Further, an aerial image display device of another embodiment is an aerial image display device that displays an aerial image on a first reflective surface including a first direction and a second direction intersecting the first direction, the aerial image display device including: a display having a display surface facing from one end side to the other end side in the first direction; and a retro-transmissive element, in which at least a part of first emission light based on display on the display surface is transmitted through the retro-transmissive element from the other end side toward the one end side in the first direction, at least a part of the transmitted first emission light is reflected by the first reflective surface, and at least a part of the first emission light reflected by the first reflective surface forms the aerial image.

### Advantageous Effects of Invention

According to embodiments, it is possible to provide means for preventing reduction in luminance and image quality caused by a measure for removing an influence of transmission light.

### BRIEF DESCRIPTION OF DRAWINGS

FIG. 1 is a block diagram showing an example of a configuration of an aerial image display device according to a first embodiment.

FIG. 2 is a schematic diagram showing an example of a configuration of a system including the aerial image display device according to the first embodiment.

FIG. 3 is a schematic diagram showing an example of a configuration of a system including an aerial image display device according to a second embodiment.

FIG. 4 is a schematic diagram showing an example of a configuration of a system including an aerial image display device according to a third embodiment.

FIG. 5 is a schematic diagram showing an example of a configuration of a system including an aerial image display device according to a fourth embodiment.

FIG. 6 is a schematic diagram showing an example of the configuration of the system including the aerial image display device according to the fourth embodiment.

FIG. 7 is a schematic diagram showing an example of the configuration of the system including the aerial image display device according to the fourth embodiment.

FIG. 8 is a schematic diagram showing an example of a configuration of a system including an aerial image display device according to a fifth embodiment.

FIG. 9 is a schematic diagram showing an example of a configuration of a system including an aerial image display device according to a sixth embodiment.

FIG. 10 is a schematic diagram showing an example of a configuration of a system including an aerial image display device according to a seventh embodiment.

FIG. 11 is a schematic diagram showing an example of a configuration of a system including an aerial image display device according to an eighth embodiment.

### DESCRIPTION OF EMBODIMENTS

Hereinafter, some embodiments will be described with reference to the drawings. Note that, in the following description, components having the same function and configuration are denoted by the same reference numerals. In the following description, two types of horizontal directions intersecting each other will be referred to as “X direction” and “Y direction”. A direction intersecting the X direction and the Y direction will be referred to as “Z direction”.

An aerial image display device described below is a device including an optical system configured to display an image on a display as an aerial image by using a reflective surface.

### 1 First Embodiment

A system including an aerial image display device according to a first embodiment will be described.

The system includes the aerial image display device and a reflective material having a reflective surface for displaying an image as an aerial image. Note that the reflective material may be included in the aerial image display device. The aerial image display device is, for example, a tabletop device.

### 1.1 Hardware Configuration

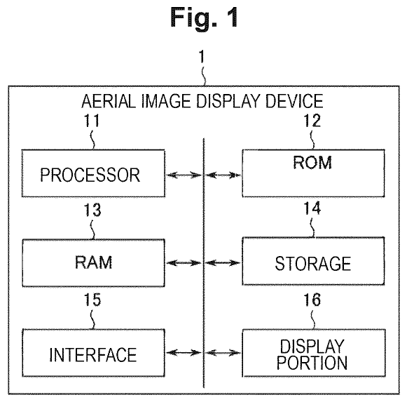

First, a hardware configuration of the aerial image display device according to the first embodiment will be described with reference to FIG. 1. FIG. 1 is a block diagram showing an example of a configuration of the aerial image display device according to the first embodiment.

The aerial image display device 1 includes, for example, a processor 11, a read only memory (ROM) 12, a random access memory (RAM) 13, a storage 14, an interface 15, and a display portion 16.

The processor 11 is a processing circuit capable of executing various programs. The processor 11 controls the entire operation of the aerial image display device 1. The processor 11 is, for example, a central processing unit (CPU) or a graphics processing unit (GPU). Note that the aerial image display device 1 may include a plurality of processors.

The ROM 12 is a nonvolatile semiconductor memory. The ROM 12 stores a program, control data, and the like for controlling the aerial image display device 1.

The RAM 13 is a volatile semiconductor memory such as a dynamic random access memory (DRAM) or a static random access memory (SRAM). The RAM 13 is used as a work area of the processor 11.

The storage 14 is a nonvolatile storage device such as a hard disc drive (HDD), a solid state drive (SSD), or a memory card. The storage 14 stores various types of information and data. The storage 14 may store image data for causing the aerial image display device 1 to display an aerial image. The storage 14 may further store a program and control data.

The interface 15 is, for example, an interface circuit capable of inputting the image data for causing the aerial image display device 1 to display an aerial image.

The display portion 16 mainly constitutes an optical system for displaying an aerial image based on the image data as a real image by using the reflective surface of the reflective material. The optical system will be described later.

### 1.2 Configuration of Optical System

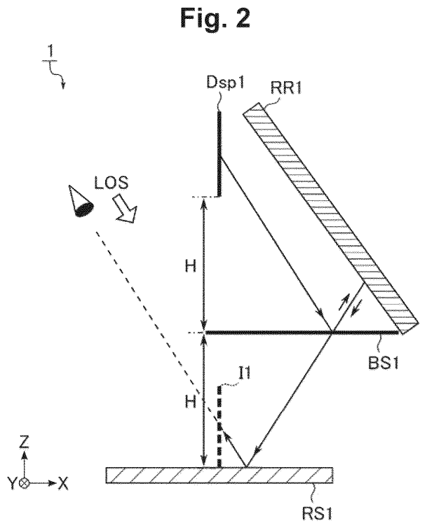

A configuration of the optical system of the system including the aerial image display device 1 will be described with reference to FIG. 2. FIG. 2 is a schematic diagram showing an example of a configuration of the system including the aerial image display device according to the first embodiment. FIG. 2 shows a configuration of the system including the aerial image display device 1 when viewed in the Y direction. The schematic diagram showing the configuration of the system including the aerial image display device also shows a line-of-sight direction LOS of a user and an aerial image displayed by the system. Note that, in the following description, of the user and the aerial image display device 1, the user side will be referred to as one end side in the X direction. Meanwhile, of the user and the aerial image display device 1, the aerial image display device 1 side will be referred to as the other end side in the X direction.

The optical system of the system including the aerial image display device 1 includes a display Dsp1, a reflector RR1, a beam splitter BS1, and a reflective material RS1. The display Dsp1, the reflector RR1, and the beam splitter BS1 are included in the display portion 16 of the aerial image display device 1.

The display Dsp1 is, for example, a flat display in which a display surface of an image is arranged on the YZ plane. The display Dsp1 is arranged such that the display surface faces from the one end side to the other end side in the X direction. That is, the display Dsp1 is arranged such that the user does not directly view the display surface. Note that the display Dsp1 only needs to be arranged such that the display surface faces from the one end side to the other end side in the X direction, and although not shown in FIG. 2, the display Dsp1 may be inclined to be higher from the one end side toward the other end side in the X direction.

The reflector RR1 is a retro-reflective material having a reflective surface configured to retro-reflect incident light. The reflector RR1 is, for example, a prismatic retro-reflective material or a bead retro-reflective material. For example, the reflector RR1 is arranged such that the reflective surface and the display surface of the display Dsp1 face each other when viewed in the Y direction. For example, the reflector RR1 is arranged such that the reflective surface faces from the other end side to the one end side in the X direction. In the first embodiment, for example, the reflector RR1 is inclined to be lowered from the one end side toward the other end side in the X direction.

The beam splitter BS1 is, for example, a non-polarizing beam splitter. The beam splitter BS1 is arranged, for example, in parallel to the XY plane below the display Dsp1. The length in the Z direction (the length on an extension line of the display surface) between the beam splitter BS1 or its extension line and the lower end of the display surface of the display Dsp1 is a length H.

The reflective material RS1 is, for example, a nearby component having a flat surface such as a table. A reflective surface of the reflective material RS1 is, for example, an upper surface of the table or the like. Note that the reflective surface of the reflective material RS1 may be, for example, a flat surface on which a half mirror, a glossy film, or the like is installed or may be a flat surface on which the reflective surface is formed by applying a brightener. As described above, the reflective material RS1 may be included in the aerial image display device 1. In this case, for example, the reflective material RS1 is a half mirror or the like included in the aerial image display device 1.

The reflective surface of the reflective material RS1 is parallel to the XY plane. The reflective surface is arranged on an upper surface of the reflective material RS1. The reflective material RS1 is located below the beam splitter BS1. The length in the Z direction between the reflective surface of the reflective material RS1 and the beam splitter BS1 or its extension line is equal to the length H, for example.

In the above configuration, as indicated by the solid arrows in FIG. 2, at least a part of emission light based on an image on the display Dsp1 is specularly reflected by the beam splitter BS1, for example. At least a part of the emission light reflected by the beam splitter BS1 is retro-reflected by the reflector RR1 and is transmitted through the beam splitter BS1. At least a part of the emission light transmitted through the beam splitter BS1 is specularly reflected by the reflective material RS1. Then, an aerial image I1 is formed on the reflective surface of the reflective material RS1 by the light reflected by the reflective material RS1. Therefore, the aerial image display device 1 is configured such that the user can observe the aerial image I1.

### 1.3 Effects of First Embodiment

According to the first embodiment, the aerial image display device 1 includes the display Dsp1 having the display surface facing from the one end side to the other end side in the X direction, the beam splitter BS1, and the reflector RR1. The aerial image display device 1 is configured such that at least a part of emission light based on display on the display surface of the display Dsp1 is transmitted through the beam splitter BS1 from the other end side to the one end side in the X direction by the beam splitter BS1 and the reflector RR1. The aerial image display device 1 is also configured such that at least a part of the emission light transmitted in this manner is reflected by the reflective surface of the reflective material RS1 parallel to the XY plane, thereby forming an aerial image. With the above configuration, the emission light from the display surface of the display Dsp1 is prevented from being directly observed by the user. This prevents reduction in image quality such as luminance and resolution of the aerial image caused by a measure for removing an influence of transmission light.

In addition, for example, in a case where the display is arranged such that a direction of the display surface of the display and the line-of-sight direction face each other, a visual field control film is provided to remove the influence of transmission light that is simply transmitted through a retro-transmissive element such as a micro mirror array plate (MMAP) without being retro-transmitted through the retro-transmissive element. However, in this case, the intensity of the transmission light is reduced, and the light intensity of the aerial image is also reduced. This causes a problem of reduction in luminance and image quality of the aerial image.

According to the first embodiment, with the above configuration, no visual field control film is provided because the direction of the display surface of the display Dsp1 and the line-of-sight direction LOS do not face each Other. Therefore, the light intensity is not reduced by the visual field control film. This prevents reduction in luminance and image quality of the aerial image.

According to the first embodiment, because the light reflected by the reflective surface of the reflective material RS1 is observed as the aerial image I1, deterioration and the like in aerial image caused by the light reflected by the reflective material is suppressed. This also prevents reduction in luminance and image quality of the aerial image.

The optical system of the first embodiment is configured by using the reflector RR1 and the beam splitter BS1. Therefore, it is easy to increase the size of the optical system as compared with a case where a retro-transmissive element such as an MMAP is used. This suppresses the size of the aerial image from being limited by limitation of the size of the optical system.

In a case where the display Dsp1 is inclined to be higher from the one end side toward the other end side in the X direction, emission light having high luminance emitted in the front direction of the display Dsp1 can be efficiently incident on the beam splitter BS1. This makes it possible to improve the luminance of the aerial image.

### 2 Second Embodiment

Next, a system including an aerial image display device according to a second embodiment will be described.

The second embodiment is different from the first embodiment in that a beam splitter is arranged such that the beam splitter or its extension line intersects a reflective surface of a reflective material or its extension line when viewed in the Y direction. Hereinafter, a configuration different from that of the first embodiment will be mainly described.

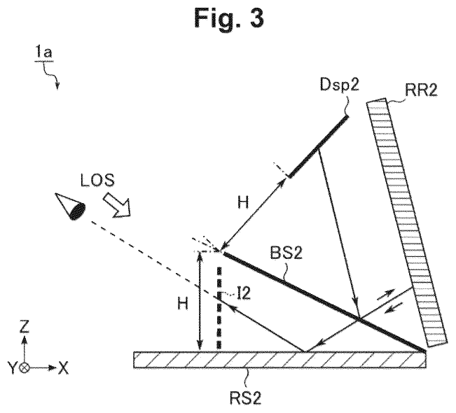

A configuration of an optical system of a system including an aerial image display device 1a will be described with reference to FIG. 3. FIG. 3 is a schematic diagram showing an example of a configuration of the system including the aerial image display device according to the second embodiment.

The optical system of the system including the aerial image display device la includes a display Dsp2, a reflector RR2, a beam splitter BS2, and a reflective material RS2.

When viewed in the Y direction, for example, the display Dsp2 is inclined to be higher from the one end side toward the other end side in the X direction.

The beam splitter BS2 is inclined to be lower from the one end side toward the other end side in the X direction. Therefore, the beam splitter BS2 is arranged such that the beam splitter BS2 or its extension line intersects the reflective material RS2 or its extension line when viewed in the Y direction. For example, the beam splitter BS2 may be provided such that the other end of the beam splitter BS2 is in contact with a reflective surface of the reflective material RS2.

In the second embodiment, a reflective surface of the reflector RR2 may be orthogonal to the line-of-sight direction LOS when viewed in the Y direction. In this case, the beam splitter BS2 may be arranged in parallel to the YZ plane or be inclined to be higher from the one end side toward the other end side in the X direction.

In the above configuration, the length on an extension line of the display Dsp2 between the lower end of the display Dsp2 and the beam splitter BS2 or its extension line when viewed in the Y direction is, for example, the length H. At a position in the X direction where an aerial image I2 is formed, the length in the Z direction between the reflective surface of the reflective material RS2 and the beam splitter BS2 or its extension line is equal to the length H, for example. The length corresponds to the length between the beam splitter or its extension line and the reflective surface of the reflective material in the first embodiment.

The second embodiment also has effects similar to those of the first embodiment.

According to the second embodiment, the beam splitter BS2 is arranged such that the beam splitter BS2 or its extension line intersects the reflective material RS2 or its extension line when viewed in the Y direction. Further, when viewed in the Y direction, for example, the display Dsp2 is inclined to be higher from the one end side toward the other end side in the X direction. With the above configuration, the aerial image display device la is configured such that light having high luminance emitted in the front direction of the display Dsp2 is efficiently incident on the beam splitter BS2. With such a configuration, it is possible to suppress reduction in luminance of the aerial image.

Because the beam splitter BS2 is provided to be inclined with respect to the reflective material RS2 as described above, it is possible to suppress the aerial image display device 1 from becoming high in the Z direction.

Further, in a case where the reflector RR2 is provided to be orthogonal to the line-of-sight direction LOS when viewed in the Y direction as described above, it is possible to suppress reduction in luminance of the aerial image if the reflector RR2 is a prismatic retro-reflective material. That is, when an incident angle on the prismatic retro-reflective material is set to around 0 degrees, reflectance of the reflector RR2 is improved, thereby suppressing reduction in luminance. Even in a case where the reflector RR2 is a bead retro-reflective material, light reflected by the reflector RR2 and the line-of-sight direction LOS become close to parallel to each other, and thus, for example, reduction in luminance and a change in luminance when the line-of-sight direction LOS is moved up and down are suppressed.

### 3 Third Embodiment

Next, a system including an aerial image display device according to a third embodiment will be described.

The third embodiment is different from the first embodiment in that the system including the aerial image display device displays an image crossing a reflective surface of a reflective material. Hereinafter, a configuration different from that of the first embodiment will be mainly described.

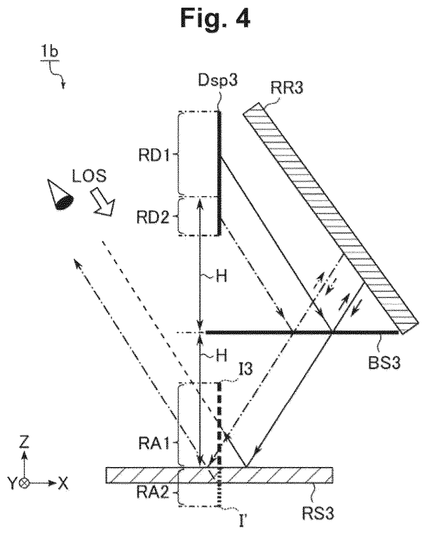

A configuration of an optical system of a system including an aerial image display device 1b will be described with reference to FIG. 4. FIG. 4 is a schematic diagram showing an example of a configuration of the system including the aerial image display device according to the third embodiment.

The optical system of the system including the aerial image display device 1b includes a display Dsp3, a reflector RR3, a beam splitter BS3, and a reflective material RS3.

When viewed in the Y direction, the display Dsp3 is arranged such that the length in the Z direction (a length on an extension line of the display surface) between the lower end of the display Dsp3 and the beam splitter BS3 or its extension line is shorter than the length H between the beam splitter BS3 or its extension line and a reflective surface of the reflective material RS3.

With the above configuration, an aerial image I3 is formed in, for example, a region RA1 having a height from the reflective surface of the reflective material RS3 as indicated by the solid line in FIG. 4 by at least a part of emission light from a portion of the display Dsp3 included in a region RD1 where the length along the Z direction from the beam splitter BS3 is equal to or more than the length H. Further, a virtual image I′ in a region RA2 below the reflective surface of the reflective material RS3 is observed as indicated by, for example, the alternate long and short dash line in FIG. 4 by at least a part of emission light from a portion of the display Dsp3 included in a region RD2 where the length along the Z direction from the beam splitter BS3 is less than the length H.

The third embodiment also has effects similar to those of the first embodiment.

According to the third embodiment, the aerial image I3 is displayed as an image crossing the reflective surface of the reflective material RS3, and thus image expression can be enlarged. A system that implements such image expression can be completed on a tabletop.

### 4 Fourth Embodiment

Next, a system including an aerial image display device according to a fourth embodiment will be described.

The fourth embodiment is different from the first embodiment in that the aerial image display device includes a mirror for using light emitted from a display in a lateral direction to form an aerial image. Hereinafter, a configuration different from that of the first embodiment will be mainly described.

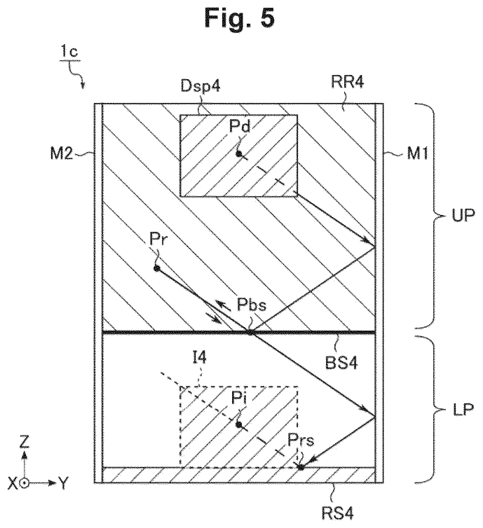

A configuration of an optical system of a system including an aerial image display device 1c will be described with reference to FIG. 5. FIG. 5 is a schematic diagram showing an example of a configuration of the system including the aerial image display device according to the fourth embodiment. FIG. 5 is a schematic diagram showing the aerial image display device viewed from the X direction.

The optical system of the system including the aerial image display device 1c includes a display Dsp4, a reflector RR4, a beam splitter BS4, a reflective material RS4, and mirrors M1 and M2. The display Dsp4, the reflector RR4, the beam splitter BS4, and the mirrors M1 and M2 are included in the display portion 16.

In the following description, a region above the beam splitter BS4 and a region below the beam splitter BS4 will be referred to as regions UP and LP, respectively.

The mirrors M1 and M2 are, for example, mirrors or beam splitters. In a case where the mirrors M1 and M2 are beam splitters, a reflection polarization characteristic may be given to the beam splitters to suppress reduction in luminance. In this case, a direction of a reflection axis of the beam splitter needs to be aligned with a reflection axis of the beam splitter BS4 in a portion included in the region UP and to be aligned with a transmission axis in a portion included in the region LP. The mirrors M1 and M2 are arranged such that reflective surfaces of the mirrors M1 and M2 intersect a reflective surface of the reflective material RS4. The mirrors M1 and M2 are arranged, for example, such that the reflective surfaces of the mirrors M1 and M2 are parallel to the XZ plane. The mirrors M1 and M2 are arranged such that the reflective surfaces of the mirrors M1 and M2 face each other. The mirrors M1 and M2 are arranged to interpose the display Dsp4, the reflector RR4, the beam splitter BS4, and the reflective surface of the reflective material RS4 therebetween. The mirrors M1 and M2 are provided, for example, from a height equal to or less than the reflective surface of the reflective material RS4 to a height equal to or more than the upper end of the reflector RR4.

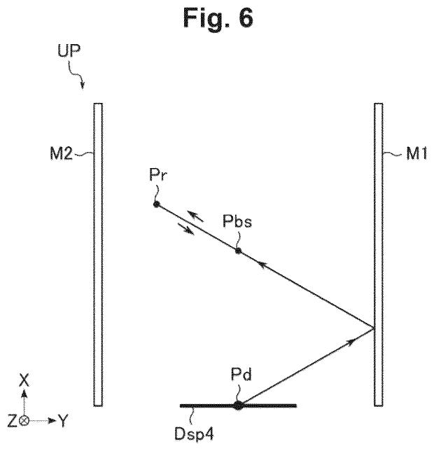

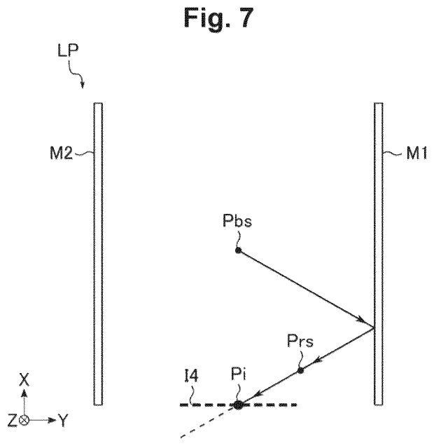

An optical path in the above configuration will be described with reference to FIGS. 6 and 7 in addition to FIG. 5. FIGS. 6 and 7 are schematic diagrams showing an example of the configuration of the system including the aerial image display device according to the fourth embodiment. FIG. 6 shows an example of the system including the aerial image display device in the region UP when viewed from the Z direction. FIG. 7 shows an example of the system including the aerial image display device in the region LP when viewed from the Z direction. In FIGS. 6 and 7, the reflector RR4 and the reflective material RS4 are not shown for easy understanding of the drawings.

Hereinafter, emission light of the display Dsp4 from the display Dsp4 toward the mirror M1 will be described as an example. Note that the same applies to emission light of the display Dsp4 from the display Dsp4 toward the mirror M2 except that an optical path is symmetrical with respect to the Y direction.

At least a part of the emission light emitted from a point Pd in the display Dsp4 toward the mirror M1 is specularly reflected by the mirror M1, for example. At least a part of the emission light reflected by the mirror M1 is specularly reflected at a point Pbs of the beam splitter BS4. At least a part of the emission light reflected at the point Pbs is retro-reflected at a point Pr of the reflector RR4. At least a part of the emission light reflected at the point Pr is transmitted through the beam splitter BS4 at the point Pbs. At least a part of the emission light transmitted at the point Pbs is specularly reflected again by the mirror M1 in the region LP. At least a part of the emission light reflected by the mirror M1 is specularly reflected at a point Prs on the reflective surface of the reflective material RS4. The light thus reflected contributes to formation of an aerial image 14 at an imaging point Pi.

Such a configuration also has effects similar to those of the first embodiment.

According to the fourth embodiment, because the mirrors M1 and M2 are provided, it is possible to suppress reduction in viewing area where the aerial image 14 can be observed without omission. In addition, in a case where there is no mirror that reflects light emitted from the display in the lateral direction, the viewing area of the aerial image depends on the widths in the Y direction of the reflector, the beam splitter, and the reflective surface of the reflective material. In the fourth embodiment, it is possible to prevent the aerial image from being missing by reflecting light emitted from the display in the lateral direction by using the mirrors M1 and M2 and using the light for image formation. Therefore, reduction in viewing area can be suppressed.

Further, because the mirrors M1 and M2 are arranged to be perpendicular to the reflective surface of the reflective material RS4, it is possible to effectively suppress reduction in viewing area.

### 5 Fifth Embodiment

Next, a system including an aerial image display device according to a fifth embodiment will be described.

The fifth embodiment is different from the first embodiment in that the system including the aerial image display device is configured to use a polarization characteristic of light. Hereinafter, a configuration different from that of the first embodiment will be mainly described.

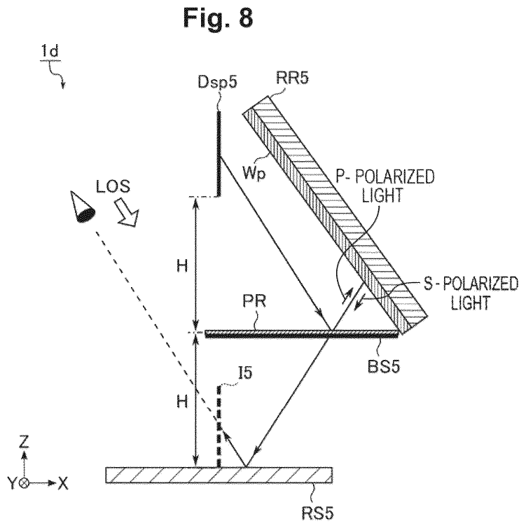

A configuration of an optical system of a system including an aerial image display device 1d will be described with reference to FIG. 8. FIG. 8 is a schematic diagram showing an example of a configuration of the system including the aerial image display device according to the fifth embodiment.

The optical system of the system including the aerial image display device 1d includes a display Dsp5, a reflector RR5, a beam splitter BS5, a reflective material RS5, a wave plate Wp, and a polarizing film PR. The display Dsp5, the reflector RR5, the beam splitter BS5, the wave plate Wp, and the polarizing film PR are included in the display portion 16.

The display Dsp5 is, for example, a polarizing display of P-polarized light or S-polarized light. FIG. 8 shows a case where the display Dsp5 is a polarizing display for P-polarized light.

The wave plate Wp is a λ/4 wave plate. The wave plate Wp covers a reflective surface of the reflector RR5.

The polarizing film PR is, for example, a reflective polarizing film that reflects P-polarized light and transmits S-polarized light in a case where the display Dsp5 is a polarizing display for P-polarized light. Further, the polarizing film PR is, for example, a reflective polarizing film that reflects S-polarized light and transmits P-polarized light in a case where the display Dsp5 is a polarizing display for S-polarized light. The polarizing film PR covers an upper surface of the beam splitter BS5. In other words, the polarizing film PR covers a surface of the beam splitter BS5 on the display Dsp5 and reflector RR5 side among the display Dsp5, the reflector RR5, and the reflective material RS5.

An optical path in the optical system of the system including the aerial image display device 1d according to the fifth embodiment will be described by using an example where the display Dsp5 is a polarizing display for P-polarized light. At least a part of P-polarized light based on an image on the display Dsp5 is specularly reflected by the beam splitter BS5. When at least a part of the P-polarized light reflected by the polarizing film PR is retro-reflected by the reflector RR5 covered by the wave plate Wp, a polarization direction is rotated, and thus the part of the P-polarized light becomes S-polarized light. At least a part of the S-polarized light is transmitted through the polarizing film PR and the beam splitter BS5. At least a part of the S-polarized light transmitted through the beam splitter BS5 is specularly reflected by the reflective material RS5. Then, an aerial image I5 is formed by the light reflected by the reflective material RS5.

The fifth embodiment also has effects similar to those of the first embodiment.

According to the fifth embodiment, it is possible to improve the reflectance of light from the display Dsp5 and transmittance of light from the reflector RR5 in the beam splitter BS5 by using a polarizing display as the display Dsp5 and providing the polarizing film PR on the reflective surface of the beam splitter BS5. Also with such a configuration, it is possible to suppress reduction in luminance of the aerial image.

Although not shown, the aerial image display device 1d may further include a polarizing film provided to cover the reflective surface of the reflective material RS5. The polarizing film is a reflective polarizing film that reflects S-polarized light and transmits P-polarized light. If the aerial image display device Id includes the reflective polarizing film, the reflectance on the reflective surface of the reflective material RS5 can also be improved. Also with such a configuration, it is possible to suppress reduction in luminance of the aerial image.

### 6 Sixth Embodiment

Next, a system including an aerial image display device according to a sixth embodiment will be described.

The sixth embodiment is different from the first embodiment in that a display of a tablet terminal is used as a reflective material. Hereinafter, a configuration different from that of the first embodiment will be mainly described.

A system including an aerial image display device le according to the sixth embodiment includes a tablet terminal TAB. The aerial image display device le may be configured to communicate with the tablet terminal TAB. Therefore, for example, information and data can be transferred between the aerial image display device le and the tablet terminal TAB.

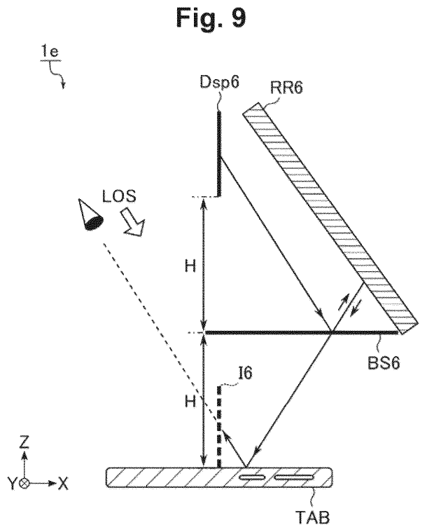

A configuration of an optical system of the system including the aerial image display device le will be described with reference to FIG. 9. FIG. 9 is a schematic diagram showing an example of a configuration of the system including the aerial image display device according to the sixth embodiment.

The optical system of the system including the aerial image display device le includes a display Dsp6, a reflector RR6, a beam splitter BS6, and the tablet terminal TAB.

As the optical system of the system including the aerial image display device le, a display of the tablet terminal TAB is used instead of the reflective material of the optical system in the first embodiment. A glossy film may be provided on the display of the tablet terminal TAB. This improves glossiness of the display of the tablet terminal TAB and suppresses roughness thereof, and thus the reflectance can be improved. This makes it possible to suppress reduction in luminance and image quality of the aerial image.

In the above configuration, the system including the aerial image display device le can display, for example, an aerial image based on an image on the display Dsp6 in combination with an image on the display of the tablet terminal TAB.

The sixth embodiment also has effects similar to those of the first embodiment.

According to the sixth embodiment, the aerial image based on the image on the display Dsp6 and the image on the display of the tablet terminal TAB are used in combination. This makes it possible to add an image parallel to a reflective surface of the reflective material RS6 to an aerial image 16 perpendicular to the reflective surface of the reflective material RS6. Therefore, image expression can be enlarged.

### 7 Seventh Embodiment

Next, a system including an aerial image display device according to a seventh embodiment will be described.

The seventh embodiment is different from the first embodiment in that a retro-transmissive optical element is used. Hereinafter, a configuration different from that of the first embodiment will be mainly described.

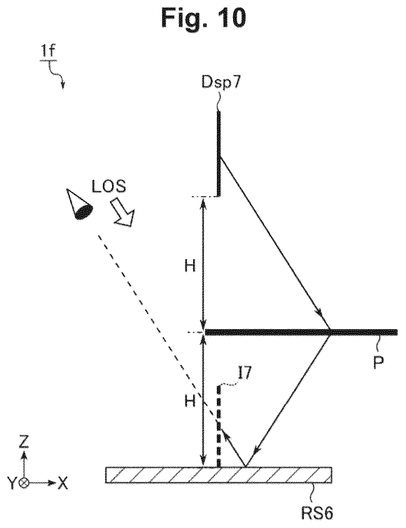

A configuration of an optical system of a system including an aerial image display device 1f according to the seventh embodiment will be described with reference to FIG. 10. FIG. 10 is a schematic diagram showing an example of a configuration of the system including the aerial image display device according to the seventh embodiment.

The optical system of the system including the aerial image display device 1f includes a display Dsp7, an element P, and a reflective material RS6. The display Dsp7 and the element P are included in the display portion 16.

The element P is a retro-transmissive element such as an MMAP. The element P is provided between the display Dsp7 and the reflective material RS6 in the Z direction. For example, the element P, as well as the reflective material RS6, is provided in parallel to the XY plane.

The element P is provided corresponding to the beam splitter in the first embodiment. Therefore, the length in the Z direction (the length on an extension line of the display surface) between the element P or its extension line and the lower end of a display surface of the display Dsp7 is the length H. Further, the length in the Z direction between a reflective surface of the reflective material RS7 and the element P or its extension line is equal to the length H, for example.

In the above configuration, as indicated by the solid arrow in FIG. 10, the element P transmits at least a part of emission light based on an image on the display Dsp7 symmetrically with respect to the element P from the other end side toward the one end side in the X direction. An aerial image 17 is formed on the reflective surface of the reflective material RS6 by at least a part of the emission light transmitted in this manner as in the first embodiment.

In the seventh embodiment, the element P, as well as the beam splitter BS2 in the second embodiment, may be inclined to be lower from the one end toward the other end in the X direction.

Even in a case where a retro-transmissive element such as an MMAP is used as in the seventh embodiment, effects similar to those of the first embodiment are obtained.

For example, the AIRR disclosed in non-patent literature 4 includes a large-sized device, and it may be difficult to complete the system on the tabletop. However, according to the configuration of the seventh embodiment, even in a case where a retro-transmissive element such as an MMAP is used, an increase in size of the device can be Suppressed, and thus the system can be completed on the tabletop. Further, according to the seventh embodiment, the structure can be simplified as compared with the AIRR disclosed in non-patent literature 4.

According to the seventh embodiment, it is possible to suppress an increase in the number of reflections even in a case where a retro-transmissive element such as an MMAP is used. For example, the configuration disclosed in non-patent literature 4 requires at least four reflections including a reflection on a mirror, two reflections inside the MMAP, and a reflection on a reflective surface. That is, in a case where the retro-transmissive element such as an MMAP is used, the number of reflections may increase. According to the seventh embodiment, with the above configuration, an aerial image is formed by at least three reflections including two reflections in the element P and a reflection on the reflective material RS6. This also suppresses reduction in luminance and image quality of the aerial image, for example.

### 8 Eighth Embodiment

Next, a system including an aerial image display device according to an eighth embodiment will be described.

The eighth embodiment is different from the first embodiment in that a reflector is arranged substantially in parallel to a beam splitter and a reflective material. Hereinafter, a configuration different from that of the first embodiment will be mainly described.

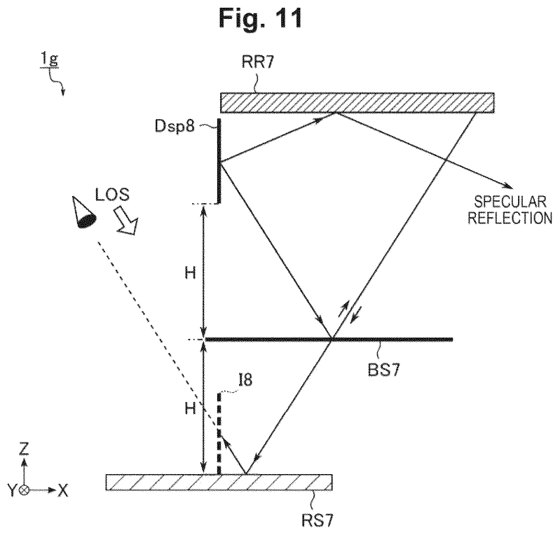

A configuration of an optical system of a system including an aerial image display device 1g according to the eighth embodiment will be described with reference to FIG. 11. FIG. 11 is a schematic diagram showing an example of a configuration of the system including the aerial image display device according to the eighth embodiment.

The optical system of the system including the aerial image display device 1g includes a display Dsp8, a reflector RR7, a beam splitter BS7, and a reflective material RS7.

The reflector RR7 is provided substantially in parallel to the XY plane. The reflector RR7 is configured such that a reflective surface of the reflector RR7 faces downward. The reflector RR7 is provided above the display Dsp8, for example.

The eighth embodiment also has effects similar to those of the first embodiment.

According to the eighth embodiment, stray light generated by being specularly reflected instead of being retro-reflected by the reflector RR7 can be prevented from being observed. In addition, for example, a part of emission light emitted from the display may be specularly reflected by the reflector. The light specularly reflected by the reflector in this manner becomes stray light that does not contribute to formation of an aerial image. According to the eighth embodiment, the optical system of the system including the aerial image display device 1g is configured such that stray light caused by such specular reflection on the reflector is directed to the other end side in the X direction as shown in FIG. 11. This prevents the user from observing the stray light caused by the reflector.

### 9 Modifications and the Like

Various modifications can be applied to the first embodiment, the second embodiment, the third embodiment, the fourth embodiment, the fifth embodiment, the sixth embodiment, the seventh embodiment, and the eighth embodiment described above.

For example, at least one of the arrangements of the display in the third embodiment, the provision of the mirror in the fourth embodiment, the provision of the wave plate and the polarizing film in the fifth embodiment, and the use of the tablet in the sixth embodiment may be combined with the first embodiment, the second embodiment, or the eighth embodiment. Further, for example, at least one of the arrangements of the display in the third embodiment, the provision of the mirror in the fourth embodiment, the provision of the wave plate and the polarizing film in the fifth embodiment, and the use of the tablet in the sixth embodiment may be combined with the seventh embodiment.

The display used in the above first to eighth embodiments may be a stereoscopic display. In this case, the system including the aerial image display device can display a stereoscopic aerial image as an aerial image.

In the above first to eighth embodiments, the configuration of the optical system of the system including the aerial image display device may be inverted in the Z direction. That is, the optical system of the system including the aerial image display device may have a configuration in which the configuration of the optical system of the above first to eighth embodiments is vertically inverted. In this case, the optical system of the system including the aerial image display device may be configured such that, for example, the reflective material is located above the display. The reflective surface of the reflective material is, for example, a ceiling surface instead of the upper surface of the table. Further, in a case where the reflector is included in the aerial image display device, for example, the reflective material may be a half mirror or the like included in the aerial image display device.

In the above first to eighth embodiments, the configuration of the optical system of the system including the aerial image display device may be rotated clockwise or Counterclockwise by 90 °with the Y direction as a rotation axis. In this case, the reflective surface of the reflective material is, for example, a wall surface or the like instead of the upper surface of the table. In a case where the reflective material is included in the aerial image display device, for example, the reflective material may be a half mirror or the like included in the aerial image display device and having a reflective surface parallel to the YZ plane.

Note that the present invention is not limited to the above embodiments, and various modifications can be made in the implementation stage without departing from the gist thereof. Moreover, embodiments may be implemented in appropriate combination, and in that case, a combined effect can be obtained. Furthermore, the above embodiments include various inventions, and various inventions can be extracted by a combination selected from the plurality of disclosed components. For example, even if some components are deleted from all the components described in the embodiments, a configuration from which the components are deleted can be extracted as an invention in a case where the problems can be solved and the effects can be obtained.

### REFERENCE SIGNS LIST

1, 1a, 1b, 1c, 1d, 1e, 1f, 1g Aerial image display device
Dsp1, Dsp2, Dsp3, Dsp4, Dsp5, Dsp6, Dsp7, Dsp8 Display
RR1, RR2, RR3, RR4, RR5, RR6, RR7 Reflector
BS1, BS2, BS3, BS4, BS5, BS6, BS7 Beam splitter
RS1, RS2, RS3, RS4, RS5, RS6, RS7 Reflective material
Wp Wave plate
PR Polarizing film
M1, M2 Mirror
I1, I2, I3, I4, I5, I6, I7, I8 Aerial image
I′ Virtual image

1. An aerial image display device comprising:
a display having a display surface facing from one end side to an other end side in a first direction, an aerial image being displayed on a first reflective surface including the first direction and a second direction intersecting the first direction;
a beam splitter having a second reflective surface; and
a retro-reflective material having a third reflective surface facing from the other end side to the one end side in the first direction, wherein
at least a part of first emission light based on display on the display surface is reflected by the second reflective surface of the beam splitter, at least a part of the reflected first emission light is retro-reflected by the third reflective surface of the retro-reflective material, at least a part of the retro-reflected first emission light is transmitted through the beam splitter from the other end side toward the one end side in the first direction, at least a part of the transmitted first emission light is reflected by the first reflective surface, and at least a part of the first emission light reflected by the first reflective surface forms the aerial image.

2. The aerial image display device according to claim 1, wherein
the second reflective surface of the beam splitter is arranged to intersect the first reflective surface.

3. The aerial image display device according to claim 1, wherein
a length on an extension line of the display between the display and the beam splitter is shorter than a length between the first reflective surface and the beam splitter at a position where the aerial image is formed.

4. The aerial image display device according to claim 1, further comprising:
a first mirror provided to intersect the first reflective surface; and
a second mirror provided to intersect the first reflective surface, wherein
the display and the beam splitter are arranged to be interposed between the first mirror and the second mirror.

5. The aerial image display device according to claim 1, further comprising:
a polarizing film provided to cover the second reflective surface; and
a wave plate provided to cover the third reflective surface, wherein the display is a polarizing display that emits first linearly polarized light, and the polarizing film reflects the first linearly polarized light and transmits second linearly polarized light different from the first linearly polarized light.

6. An aerial image display device comprising:
a display having a display surface facing from one end side to an other end side in a first direction, an aerial image being displayed on a first reflective surface including the first direction and a second direction intersecting the first direction; and
a retro-transmissive element, wherein
at least a part of first emission light based on display on the display surface is transmitted through the retro-transmissive element from the other end side toward the one end side in the first direction, at least a part of the transmitted first emission light is reflected by the first reflective surface, and at least a part of the first emission light reflected by the first reflective surface forms the aerial image.

7. The aerial image display device according to claim 1, wherein
an upper surface of a table, a ceiling surface, a wall surface, or a display of a terminal is used as the first reflective surface.

8. The aerial image display device according to claim 6, wherein
an upper surface of a table, a ceiling surface, a wall surface, or a display of a terminal is used as the first reflective surface.
